(19) United States
(12) Patent Application Publication
(10) Pub. No.: US 2022/0358421 A1
(43) Pub. Date: Nov. 10, 2022

(54) SCHEDULER AND, IN PARTICULAR COMPUTER IMPLEMENTED, METHOD OF MACHINE SCHEDULING FOR PERFORMING A SET OF JOBS OF A TASK WITH A SET OF MACHINES

(71) Applicant: Robert Bosch GmbH, Stuttgart (DE)

(72) Inventors: Johannes Oetsch, Wien (AT); Nysret Musliu, Wien (AT); Peter Skocovsky, Wien (AT); Thomas Eiter, Wien (AT); Tobias Geibinger, Wien (AT); Daria Stepanova, Leonberg (DE)

(21) Appl. No.: 17/656,264

(22) Filed: Mar. 24, 2022

(30) Foreign Application Priority Data
Apr. 22, 2021 (DE) 10 2021 204 043.8

(51) Int. Cl. G06Q 10/04; G06F 9/50

(52) U.S. Cl. CPC G06Q 10/04; G06F 9/5038; G06F 9/5022

(57) ABSTRACT

Machine scheduling for executing a set of jobs of a task with a set of machines. The scheduling includes determining in a first iteration a first schedule that solves an optimization problem, the optimization problem is defined by a set of rules that assign the set of jobs to the set of machines, the first schedule maps each job to one machine of the set that is capable of processing this job, an execution of jobs assigned to a machine are scheduled to be finished in a machine span, and in a second iteration either determining a constraint for a machine span and determining a second schedule that solves the optimization problem for the set of jobs and the set of machines under the constraint, or determining a second schedule that solves the optimization problem for a sub-set of the set of jobs and of the set of machines.

### CROSS REFERENCE

The present application claims the benefit under 35 U.S.C. § 119 of German Patent Application No. DE 10 2021 204 043.8 filed on Apr. 22, 2021, which is expressly incorporated herein by reference in its entirety.

### FIELD

The present invention relates to a scheduler and an in particular computer implemented method machine scheduling for performing a set of jobs of a task with a set of machines.

### BACKGROUND INFORMATION

Dimitrios Letsios, Miten Mistry, Ruth Misener “Exact lexicographic scheduling and approximate rescheduling”, European Journal of Operational Research Volume 290, Issue 2, 16 Apr. 2021, Pages 469-478 describes aspects of a related scheduling approach.

Further methods of machine scheduling are described in U.S. Patent Application Publication No. US 2020/0320456 A1, German Patent Application Nos. DE 695 13 877 T2, DE 10 2016 204 392 A1 and U.S. Pat. No. 9,798,947 B2

### SUMMARY

The scheduler, the computer program, and the in particular computer implemented method of machine scheduling according to the present invention may achieve an object of improving the scheduling and to make is useable directly for more complex scheduling problems that involve machine dedication, sequence-dependent setup times, and release dates and to ensure that the specification of the scheduling problem is easier to maintain when requirements change.

In accordance with an example embodiment of the present invention, the, in particular, computer implemented method of machine scheduling for executing a set of jobs of a task with a set of machines comprises determining in a first iteration a first schedule that solves an optimization problem, wherein the optimization problem is defined by a set of rules that assign the set of jobs to the set of machines, wherein the first schedule maps each job of the set of jobs to one machine of the set of machines that is capable of processing this job, wherein an execution of jobs that the first schedule assigns to a machine by this machine are scheduled to be finished in a machine span, and in a second iteration either determining a constraint for at least one machine span and determining a second schedule that solves the optimization problem for the set of jobs and the set of machines under the constraint, or determining a second schedule that solves the optimization problem for a sub-set of the set of jobs and a sub-set of the set of machines, wherein the sub-set of the set of machines excludes the machine and the sub-set of the set of jobs excludes jobs that are assigned to the machine according to the first schedule. This method can be used directly for more complex scheduling problems that involve machine dedication, sequence-dependent setup times, and release dates. Moreover, another advantage is that the specification of the scheduling problem is easier to maintain when requirements change as the method is applicable to a state-of-the-art knowledge-representation and reasoning solver with a respective modelling language.

In accordance with an example embodiment of the present invention, the method may comprise selecting a machine from the set of machines having a machine span that ends at a makespan for executing the task according to the first schedule and forming the sub-set of the set of machines without at least one machine. This reduces the complexity in the optimization problem with respect to the machines.

In accordance with an example embodiment of the present invention, the method may comprise forming the sub-set of the set of jobs without at least one job that is assigned to the machine. This reduces the complexity in the optimization problem with respect to the jobs.

In accordance with an example embodiment of the present invention, the method may comprise determining a plurality of machine spans for machines of the set of machines that are scheduled to execute at least one job according to the first schedule, wherein a machine span having a longer duration than at least one other machine span of the plurality of machine spans is selected as the constraint from the plurality of machine spans. This constrains the solution of the optimization problem by the machine span that has a longer duration than other machine spans. Thus, the solution is determined very efficiently.

In accordance with an example embodiment of the present invention, the method may comprise determining a sequence in which jobs that are assigned to the machine are scheduled to be processed on this machine and determining the machine span depending on a completion time of a last job in the sequence. This allows determining the machine span to increase the robustness of the scheduling method.

In accordance with an example embodiment of the present invention, the method may comprise determining the completion time of the last job depending on a sum of a start time of a first job in the sequence and a sum of processing times of at least one job in the sequence that is scheduled to start earlier than the last job and a duration of the last job. Thus, the completion time of the last job is determined very precisely. This increases the robustness of the scheduling method further.

In accordance with an example embodiment of the present invention, the method may comprise determining a plurality of schedules in a plurality of iterations, limiting a number of iterations to be less than a number of machines in the plurality of machines. This makes the scheduling much faster.

In accordance with an example embodiment of the present invention, the method may comprise scheduling at least one machine of the set of machines to execute at least one job of the set of jobs according to the second schedule. This way, the machines are scheduled very efficiently.

In accordance with the present invention, a scheduler, for executing a set of jobs of a task with a set of machines in a makespan is configured to execute steps of the example method(s).

In accordance with the present invention, a computer program comprises computer readable instructions that, when executed by a computer, cause the computer to perform steps in the example method(s).

Further advantageous embodiments of the present invention are derivable from the following description and figures.

### BRIEF DESCRIPTION OF THE DRAWINGS

FIG. 1 schematically depicts at least a part of a scheduler for a set of machines, in accordance with an example embodiment of the present invention.

FIG. 2 schematically depicts steps performed by the scheduler, in accordance with an example embodiment of the present invention.

FIG. 3 schematically depicts steps in a first method, in accordance with an example embodiment of the present invention.

FIG. 4 schematically depicts steps in a second method, in accordance with an example embodiment of the present invention.

### DETAILED DESCRIPTION OF EXAMPLE EMBODIMENTS

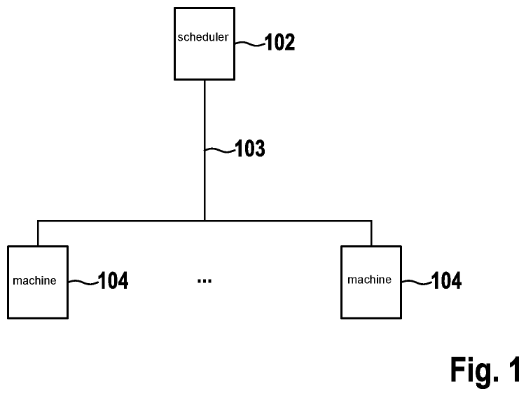

FIG. 1 schematically depicts at least a part of a scheduler 102 for a set of machines K. The scheduler 102 may comprise at least one processor and at least one memory, in particular memory for storing computer readable instructions, that when executed by at least one processor of the scheduler 102 cause the scheduler 102 to execute a method in particular a computer implemented method, of scheduling that is described below. The set of machines (designate below as K, not shown in the Figures) represents a plurality of machines 104. The scheduler 102 and the machines of the plurality of machines 104 in the example are at least temporarily connected via a data link 103. The scheduler 102 in the example is configured for instructing at least some of the machines of the plurality of machines 104 to execute jobs of a set of jobs (designated below as J, not shown in the figures).

The Method Solves a Scheduling Problem:

Given m machines k in the set of machines K and n jobs j in the set of jobs J, every job j needs to be processed by a single machine k, and every machine k can process at most one job j at a time; preemption is not allowed.

Some machines k can only handle certain jobs j; cap(j) is a set of machines that is capable of processing job j.

A release date r_{j;k} is specified for every job j and machine k as a non-negative integer. Release dates are machine dependent because transportation time for jobs to the machines depends on the transport system and their location. No job j can start before its release date r_{j;k}.

A specified amount of time may be required to change from one job j to the next one. A time s_{i;j;k} is the time needed to set up job j directly after job i on machine k.

These times are referred to as sequence-dependent setup times. Every job j has a duration d_{j;k} that depends on the machine k it is assigned to.

A Schedule for a Problem Instance is Defined by:

1. an assignment α that maps each job j to a machine k ∈ cap(j) capable of processing it;

2. for each machine k, a total order [symbol] on the set J of jobs j assigned to the machine k via the assignment α.

The relation [symbol] determines the sequence in which the jobs j in the set of jobs J are processed on machine k.

If each job j can be processed by some machine k, then at least one schedule for the problem instance exists.

Assume that j₁, . . . , jₗ is a processing sequence of the jobs j assigned to machine k in a given schedule. The processing time pⱼᵢ of a job jᵢ is its duration plus the setup-up time for its predecessor, if one exists; i.e., pⱼ₁=d_{j1;k} and pⱼᵢ=s_{ji-1;ji;k}+d_{ji;k}, for i>1. A start time stⱼᵢ of job jᵢ is r_{ji;k} if i=1, and max(r_{ji;k}; stⱼᵢ₋₁) for i>1. A completion time cⱼᵢ of job jᵢ is stⱼᵢ+pⱼᵢ. A machine span of machine k, span(k), is the completion time of the last job jₗ on machine k.

The goal is to maximize a throughput which in the example is defined as a number of jobs j processed per time unit. In principle, minimizing a makespan, i.e., a largest machine span of the schedule, accomplishes this. However, when dealing with machines with high dedication, we often find that many jobs can be processed only by few machines. This means that few machines determine the makespan almost regardless of how jobs are scheduled on the remaining ones. This is not ideal when jobs need to be dynamically rescheduled because of, e.g., sudden machine failure which can happen any time. For such cases, domain experts expressed the requirement that “all machines should complete as early as possible”. This gives the scheduler freedom for rearrangements and helps to maintain a high throughput.

To deal with this problem the method uses an objective function which aims at capturing a desire that all machines complete as early as possible. The objective function is referred to in the following as lexicographical makespan.

The lexicographical makespan of a schedule is defined as a tuple of all machine spans in non-ascending order. The method uses a lexicographical order of the tuples of different schedules for comparison and prefers a schedule with smaller lexicographical makespan over a schedule with a larger one. A resulting schedule is the schedule with minimal lexicographical makespan. The resulting schedule has therefore also a minimal makespan, but ties are broken using machines that complete earlier.

For computing schedules with minimal lexicographical makespan, an exemplary exact algorithm and an exemplary approximate algorithm are described below. Both use Answer-Set Programming (ASP), a logic-based approach for declarative problem solving that is for example described in:

Brewka, G., Eiter, T., Truszczy'nski, M., “Answer set programming at a glance,” Communications of the ACM 54(12), 92-103 (2011). El-Kholany, M., Gebser, M., “Job shop scheduling with multi-shot asp,” http://www.kr.tuwien.ac.at/events/taasp20/accepted.html (2020), workshop on Trends and Applications of Answer Set Programming (TAASP 2020).

An objective function, which is referred to as lexicographical makespan, formalizes the requirement that all machines should complete as early as possible.

Given a schedule S involving m machines, the lexicographical makespan of S is a tuple ms(S)=(c_1, . . . , c_m) of all the machine spans c_i of S in non-ascending order.

In this definition, c_1 is a maximal machine span and hence corresponds to the makespan according to schedule S. For schedules S and S′ involving m machines each, S has a smaller lexicographical makespan than S′ if ms(S) is smaller than ms(S′) under lexicographical order. This means that c_i<c′_i on the least index i where ms(S)=(c_1, . . . , c_m) and ms(S′)=(c′_1, . . . , c′_m) disagree.

i. For a set S of schedules, S∈S is then optimal if ms(S) is minimal over all schedules in the set S.

The dynamics of a schedule S are described as a number of machines M(S; t) that complete at or before a time point t.

When S and S′ are two, in particular different, schedules for some problem instance, then, ms(S)<ms(S′) if there is the time point t such that M(S; t)>M(S′; t), and, for every t′>t, M(S; t′)≥M(S′; t′).

For problems involving many machines, hierarchically minimizing all the machine spans can be excessive if the overall makespan is dominated by few machines only. However, comparing lexicographical makespans allows for a parametrization with an integer 1 that defines a number of components to consider in the comparison.

For schedules S and S′ involving m machines each and with the integer l, 1≤l≤m, the makespan according to schedule S ms(S)=(c_1, . . . , c_m) is smaller than the makespan according to schedule S′ ms(S′)=(c′_1, . . . , c′_m) under parametrized lexicographical order. For a schedule with m machines, the makespan is obtained if l=1 and the full lexicographical makespan is obtained if l=m.

In the example, the problem statement is modelled with a model that comprises rules that assign the set of jobs J to the set of machines K. A schedule maps each job j of the set of jobs to one machine k∈cap(j) of the set of machines K that is capable of processing this job j. An execution of jobs j that the schedule assigns to a machine k by this machine k is scheduled to be finished in a machine span c_i of this machine k.

The model and the objective function described above may be modelled with an extension of ASP with difference logic as described for example in Janhunen, T., Kaminski, R., Ostrowski, M., Schellhorn, S., Wanko, P., Schaub, T., “Clingo goes linear constraints over reals and integers,” Theory and Practice of Logic Programming 17(5-6), 872-888 (2017).

To solve an optimization problem that is defined by the model and the objective function with the exact algorithm, multi-shot solving may be used to implement multiple calls to the ASP solver in a resource-friendly way. This is for example described in Gebser, M., Kaminski, R., Kaufmann, B., Schaub, T.′ “Multi-shot asp solving with clingo,” Theory and Practice of Logic Programming 19(1), 27-82 (2019).

To solve the optimization problem with the approximate algorithm, parts of a solution may be fixed after solver calls, which allows to find near-optimal solutions in a short time.

The scheduler and method of scheduling may be applied in semiconductor manufacturing. In this aspect, the set of machines K is used to produce semiconductors. The scheduler and method of scheduling may be applied in distributed computing systems as well. The machines in this aspect may be processors or computing cores of processors or dedicated hardware for performing computing operations. The jobs are assigned to machines under certain constraints to compute feasible schedules. One of the requirements is that the schedules should be constructed so that all machines complete as early as possible. The optimization function called lexicographical makepan and the algorithms for minimizing it that are described below can be used to address this requirement and compute the desired schedules. The machines may be instructed according to the schedule that solves the optimization problem.

ASP is a compact relational, in essence propositional, formalism where variables in the input language are replaced by constant symbols in a preprocessing step called grounding. An ASP program is a set of rules of the form

p1| . . . |pk:−q1, . . . ,qm, not r1, . . . ,not rn.

where all pi, qj, and rl are atoms. A head are all atoms before the implication symbol: −, and a body are all the atoms and negated atoms afterwards. The intuitive meaning of this rule is that if all atoms q1, . . . , qm can be derived, and there is no evidence for any of the atoms r1, . . . , rn (i.e., the rule fires) then at least one of p1, . . . , pk has to be true. An interpretation I is a set of atoms. It is an answer-set of a program, if all its rules are satisfied in a minimal and consistent way. I must be a ⊆-minimal model of all rules that fire. Aspects of this are described for example in Gelfond, M., Lifschitz, V., “Classical negation in logic programs and disjunctive databases,” New generation computing 9(3-4), 365-385 (1991).

A rule with empty body is called a fact, with: − usually omitted. Facts are used to express knowledge that is unconditionally true. A rule with empty head is a constraint. The body of a constraint cannot be satisfied by any answer set and is used to prune away unwanted solution candidates.

A common syntactic extension are choice rules of the form

i{p1, . . . ,pk}j:−q1, . . . ,qm,notr1, . . . ,notrn.

The meaning is that if the rule fires, then some subset S of p1, . . . , pk with i≤|S|≤j has to be true as well.

In an example an ASP solver that uses difference logic may be used to solve the optimization problem. An example for the ASP solver ist clingo-dl (https://github.com/potassco/clingo-dl).

The difference logic may be used to solve the optimization problem under a constraint, in particular a difference constraint. The difference constraint in the example is an expression of the form u−v≤d, where u and v are integer variables and d is an integer constant.

In contrast to unrestricted integer constraints, systems of difference constraints are solvable in polynomial time. The latter may be expressed in clingo-dl using theory atoms. Theory atoms are described for example in Gebser, M., Kaminski, R., Kaufmann, B., Ostrowski, M., Schaub, T., Wanko, P., “Theory solving made easy with clingo 5,” in: Technical Communications of the 32nd International Conference on Logic Programming (ICLP 2016). Schloss Dagstuhl-Leibniz-Zentrum für Informatik (2016)

The model in the example comprises a problem instance that is described by ASP facts using some fixed predicate names.

An example with one machine m1 and two jobs j1, j2 is described below. The machine m1 is capable of processing all jobs and all release dates are 0. A setup time in the example is 4 when changing from job j1 to job j2 and 2 when changing from job j2 to job j1. Both jobs have duration 5. The according facts are

| | |
|---|---|
| 1 | { asg(J,M) : cap(M,J) } 1 :− job(J). |
| 2 | |
| 3 | before(J1,J2,M) \| before(J2,J1,M) :− asg(J1,M), |
| | asg(J2,M), J1 < J2. |
| 4 | |
| 5 | 1 { first(J,M) : asg(J,M) } 1 :− asg(_,M). |
| 6 | 1 { last(J,M) : asg(J,M) } 1 :− asg(_,M). |
| 7 | 1 { next(J1,J2,M) : before(J1,J2,M) } 1 :− asg(J2,M), |

not first(J2,M).

| | |
|---|---|
| 8 | 1 { next(J2,J1,M) : before(J2,J1,M) } 1 :− asg(J2,M), not |

last(J2,M).

| | |
|---|---|
| 9 | :− first(J1,M), before(J2,J1,M). |
| 10 | :− last(J1,M), before(J1,J2,M). |
| 11 | |
| 12 | &diff{ 0 − c(J1)} <= −(T+D+S) :− asg(J1,M), next(J3,J1,M), |
| 13 | setup(J3,J1,M,S), duration(J1,M,D), release(J1,M,T). |
| 14 | &diff{ c(J2) − c(J1) } <= −(P+S) :− before(J2,J1,M), |

next(J3,J1,M),

| | |
|---|---|
| 15 | setup(J3,J1,M,S), duration(J1,M,P). |
| 16 | &diff{ 0 − c(J1) }<=−(T+D):− asg(J1,M), duration(J1,M,D), |

release(J1,M,T).

| | |
|---|---|
| 17 | &diff{ c(J) − cmax } <= 0 :− job(J). |
| 18 | |
| 19 | &diff{ c(J2) − c(J1) } <= −P :− before(J2,J1,M), |

duration(J1,M,P).

| | |
|---|---|
| 20 | |
| 21 | 1 { span(M,T) : int(T) } 1 :− machine(M). |
| 22 | &diff{ c(J) − 0 } <= S :− asg(J,M), span(M,S). |
| 23 | #minimize{ T@T,M : span(M,T) }. |

An ASP encoding for computing minimal schedules is described below with reference to lines of the program that is given above. For every problem instance I, the schedules of I with minimal lexicographical makespan are in one-to-one correspondence with the answer sets of the rules above augmented with the fact representation of I.

The encoding in the example consists of three parts:

Lines 1-10 qualitatively model feasible sequences of jobs on machines:

Line 1 expresses that each job is assigned to a machine capable of processing it. The notation asg(J,M): cap(M,J) means that in the grounding step for each value j of the global variable J as it occurs in the body. This means asg(J,M) is replaced by all atoms asg(j,m) for which cap(j,m) can be derived.

Line 3 expresses a rule that requires that the jobs assigned to a machine are totally ordered. That is, for any two distinct such jobs j1 and j2, either j1 [symbol] j2 or j2 [symbol] j1 holds.

Line 5 defines a predicate first(J,M) that represents a first job on each machine.

Line 6 defines a predicate last(J,M) that represents a last job on each machine.

Line 7 comprises a predicate next (J1, J2, M) representing a successor of each job except the last job and a constraint on this predicate that ensures that a selection according to the predicate next (J1, J2, M) is compatible with an order given by a predicate before(J1,J2,M).

Line 8 comprises a predicate next (J2, J1, M) representing a predecessor of each job except the first job and a constraint on this predicate that ensures that a selection according to the predicate next (J2, J1, M) is compatible with an order given by a predicate before(J2,J1,M).

Line 9 comprises a constraint on the predicate first (J,M) that ensures that a selection according to the predicate first (J,M) is compatible with an order given by a predicate before(J2,J1,M).

Line 10 comprises a constraint on the predicate last (J,M) that ensures that a selection according to the predicate last (J,M) is compatible with an order given by a predicate before (J1,J2,M).

Lines 12-19 quantitative model completion times with difference logic.

Lines 12-16 model the scheduling problem described above.

Line 17 defines c max as an upper bound of any completion time. In the example, the ASP solver instantiates integer variables with a smallest value possible. Thus, in any answer-set that the solver determines, c max is the actual makespan.

Line 19 defines an additional, redundand rule. In the example, the ASP solver searches for solutions in a search space. This rule helps the ASP solver to further prune the search space.

Lines 21-23 define how solving the optimization problem is accomplished.

Line 21 defines a span for each machine. Here int(T) is assumed to provide a bounded range of integers.

Line 22 enforces that machines complete not later than the span that is defined for it.

Line 23 defines the objective function.

Notably, any machine contributes its span c to a cost function at a priority level c.

The cost function accumulates contributing values and the solver minimizes answer sets by lexicographically comparing cost tuples ordered by their priority.

The difference logic is used in this example to express that jobs are put on the machines in the order defined by any predicate next. The use of difference logic has the advantage that integer arithmetic in Boolean ASP constraints is avoided, which would increase the size of grounding.

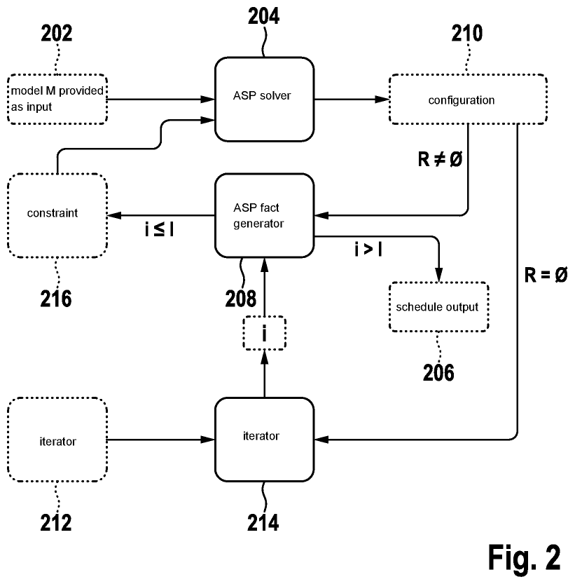

The exact algorithm is referred to as lexicographical makespan optimization and is described below referencing FIG. 2. FIG. 2 schematically depicts exemplary steps performed by the scheduler 102.

A schedule is determined in the example as a solution of the optimization problem by solving the optimization problem iteratively. The model M is provided as input 202 to an ASP solver 204. The schedule is an output 206 of an ASP fact generator 208.

The ASP solver 204 is configured to search for a solution, solve(M), for the optimization problem and to output either a non-empty set R that solves the optimization problem for M or R=Ø if none is found within fixed resource limits. A configuration 210 is configured to provide a parameter l in a range 1≤1≤m for an iterator 212. The iterator 214 provides a counter i to the ASP fact generator 208 that is incremented in a range whenever the ASP solver 204 outputs an empty set Ø. The iterator 214 is configured to start the counter i with i=1 in a first iteration and to increment the counter i by one whenever the ASP solver outputs an empty set R=Ø. The ASP fact generator 208 is configured to determine a constraint 216 depending on any non-empty set R. The constraint 216 of a first iteration i is an input for the next iteration i+1. The ASP solver 204 is configured to solve the optimization problem for M in the next iteration i+1 under this constraint 216. In the example, the constraints of previous iterations are added to the model M. The ASP fact generator 208 is in the example configured to output the schedule after a last iteration i≤l.

The exact algorithm for determining the lexicographical makespan optimization is described below.

Input: model M involving m machines and parameter l with 1≤1≤m

Output: schedule R for M with parametrized lexicographical makespan (c_1, . . . , c_m)

solve(M), returns a non-empty solution R for M or R=Ø if none is found within fixed resource limits.

bound(i^{∘}b), ^{∘}∈{<≤} constraints enforcing that c_i^{∘}b for the lexicographical makespan (c_1, . . . , c_m)

| 1 | (c_1, ..., c_l)←(0, ... , 0) |
|---|---|
| 2 | R←solve(M) |
| 3 | for i←1 to l do |
| 4 | S←R |
| 5 | while S≠ ∅ do |
| 6 | R←S |
| 7 | c_i← ith element of the lexicographical |
| makespan of S | |
| 8 | S←solve(M ∪ bound(i < c_i)) |
| 9 | M←M [ bound(i ≤ c_i) |
| 10 | return R with lexicographical makespan (c_1, ..., c_l) |

With this algorithm, schedules with minimal lexicographical makespan may be computed using multiple solver calls and incrementally adding constraints.

This represents a multi-objective minimization comprising a highest priority first hierarchical descent. Due to symmetries, showing a lack of solutions is usually more costly for this problem than finding one; this makes alternative strategies with fewer expected solver calls like binary search or exponentially increasing search steps less attractive.

In the example, clingo-dl and the encoding described above is used without the optimization statement in Lines 21-23 to implement solve(M). Using clingo-dl, which supports multi-shot solving where parts of the solver state are kept throughout multiple runs, saves computational resources. Notably solve(M) in the exact algorithm is not limited to use an ASP solver. Instead any exact method that is capable of producing solutions for a model M in the input language of the respective system may be used instead.

The constraints for bound(i≤b) are expressed for example in ASP:

The i-th component of the lexicographical makespan that is smaller than or equal to b is equivalent to enforcing that at least m−i+1 machines have a span of at most b.

In the example, the latter is encoded by non-deterministically selecting m−i+1 machines and enforcing that they complete not later than b:

(m−i+1){sel(M):machine(M)}.

&diff{span(M)−0}<=b:−sel(M).

The exact algorithm is guaranteed to return a schedule with minimal lexicographical makespan when resources for solve(M) are not limited.

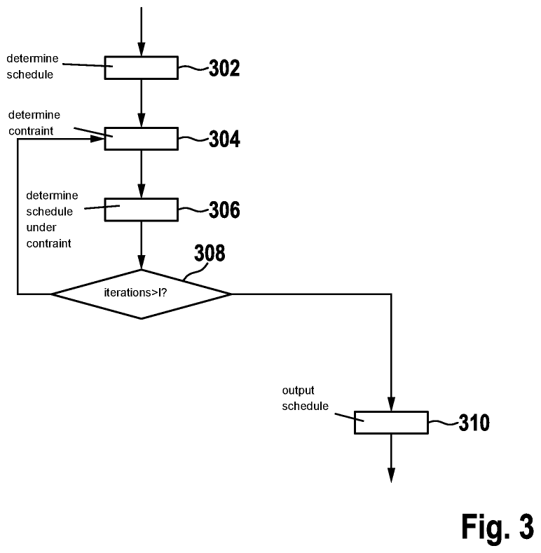

An exemplary first method of scheduling is described with reference to FIG. 3. The first method comprises a step 302. In step 302 a schedule is determined that solves the optimization problem for the set of machines K and the set of jobs J.

The optimization problem is defined by a set of rules that assign the set of jobs to the set of machines. The schedule maps each job of the set of jobs to one machine of the set of machines that is capable of processing this job.

An execution of jobs that the schedule assigns to a machine by this machine are scheduled to be finished in a machine span.

Afterwards a step 304 is executed. In the step 304 a constraint is determined for at least one machine span depending on the machine span.

Afterwards a step 306 is executed. In the step 306 a schedule is determined that solves the optimization problem for the set of jobs and the set of machines under the constraint. An execution of jobs that the schedule assigns to a machine by this machine are scheduled to be finished in a machine span.

Afterwards, a step 308 is executed. In step 308, it is determined if a counter of iterations i exceeds a parameter l or not. If the counter of iterations i exceeds the parameter l a step 310 is executed. Otherwise, the counter ist increased and step 304 is executed.

In step 310, the schedule is output as solution of the optimization problem.

In practice a time spent for search for a solution to the optimization problem may be limited by a suitable time limit.

For the approximate algorithm, a optimizer, in particular an exact optimizer, is used that is configured to find schedules with small makespans. This optimizer may use any procedure which is good at finding schedules with small makespans. This optimizer is in the example employed to compute schedules with small lexicographical makespans as described below:

Input: model M involving m machines and parameter l with 1≤1≤m

Output: schedule S for M with parametrized lexicographical makespan (c_1, . . . , c_l)

opt(M) returns best solution for M found within fixed resource limits

| | |
|---|---|
| 1 | (c_1, ..., c_l)←(0, ..., 0) |
| 2 | S← ∅; |
| 3 | for i←1 to l do |
| 4 | S←opt(M) |
| 5 | c_i ← makespan of S |
| 6 | remove some machine k that completes at c_i |
| | and all jobs assigned to k from M |
| 7 | return S |

This approximation algorithm uses the optimizer to repeatedly compute and improve parts of a solution provided by the optimizer. This requires multiple solver calls to the optimizer. A number of the solver calls is bounded by the number of machines. After each solver call, the problem instance is significantly simplified. Therefore the problem instance is easier to solve.

The optimizer may be implemented by using multi-shot solving with reuse heuristic values and learned clauses from previous solver runs.

In this example, the ASP fact generator 208 may be configured to remove in a first iteration from the model M any machine k that completes at c_i and all jobs assigned to k from M. The ASP solver 204 is in this example configured to call the optimizer for solving the so changed model M.

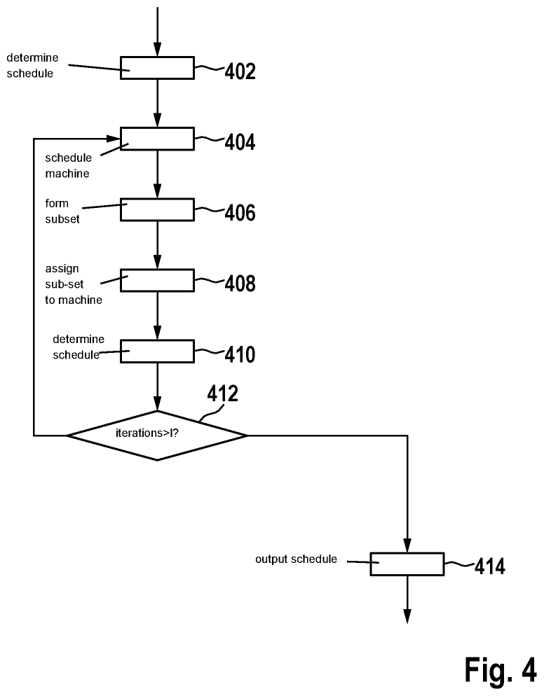

An exemplary second method of scheduling is described below with reference to FIG. 4. The second method comprises a step 402. In step 402 a schedule is determined that solves the optimization problem for the set of machines K and the set of jobs J.

Afterwards, a step 404 is executed. In step 404 at least one machine k having a machine span that is scheduled to finish at the makespan of the schedule.

Afterwards, a step 406 is executed. In step 406 a sub-set of the set of machines K without the machine k is formed.

Afterwards, a step 408 is executed. In step 408 a sub-set of the set of jobs J without jobs j that are assigned to the machine k according to the schedule is formed.

Afterwards, a step 410 is executed. In step 410 the schedule that solves the optimization problem for the sub-set of the set of jobs J and the sub-set of the set of machines K is determined.

Afterwards, a step 412 is executed. In step 412, it is determined if a counter of iterations i exceeds a parameter l or not. If the counter of iterations i exceeds the parameter l a step 414 is executed. Otherwise, the counter ist increased and step 404 is executed.

In step 414, the schedule is output as solution of the optimization problem.

What is claimed is:

1. A method computer implemented method of machine scheduling for executing a set of jobs of a task with a set of machines, the method comprising:
determining, in a first iteration, a first schedule that solves an optimization problem, wherein the optimization problem is defined by a set of rules that assign the set of jobs to the set of machines, the first schedule maps each job of the set of jobs to one machine of the set of machines that is capable of processing the job, an execution of each of the jobs that the first schedule assigns to each machine is scheduled to be finished in a machine span, and
in a second iteration, either: (i) determining a constraint for at least one of the machine spans and determining a second schedule that solves the optimization problem for the set of jobs and the set of machines under the constraint, or (ii) determining a second schedule that solves the optimization problem for a sub-set of the set of jobs and a sub-set of the set of machines, wherein the sub-set of the set of machines excludes the machine and the sub-set of the set of jobs excludes jobs that are assigned to the machine according to the first schedule.

2. The method according to claim 1, further comprising:
selecting a machine from the set of machines having a machine span that ends at a makespan for executing the task according to the first schedule and forming the sub-set of the set of machines without at least one machine.

3. The method according to claim 2, further comprising forming the sub-set of the set of jobs without at least one job that is assigned to the machine.

4. The method according to claim 1, further comprising determining a plurality of machine spans for machines of the set of machines that are scheduled to execute at least one job according to the first schedule, wherein a machine span having a longer duration than at least one other machine span of the plurality of machine spans is selected as the constraint from the plurality of machine spans.

5. The method according to claim 1, further comprising determining a sequence in which jobs that are assigned to a first machine are scheduled to be processed on the first machine and determining the machine span depending on a completion time of a last job in the sequence.

6. The method according to claim 5, further comprising determining the completion time of the last job depending on a sum of a start time of a first job in the sequence and a sum of processing times of at least one job in the sequence that is scheduled to start earlier than the last job and a duration of the last job.

7. The method according to claim 1, further comprising:
determining a plurality of schedules in a plurality of iterations, limiting a number of iterations to be less than a number of machines in the plurality of machines.

8. The method according to claim 1, further comprising scheduling at least one machine of the set of machines to execute at least one job of the set of jobs according to the second schedule.

9. A scheduler, for executing a set of jobs of a task with a set of machines in a makespan, the scheduler configured to:
determine, in a first iteration, a first schedule that solves an optimization problem, wherein the optimization problem is defined by a set of rules that assign the set of jobs to the set of machines, the first schedule maps each job of the set of jobs to one machine of the set of machines that is capable of processing the job, an execution of each of the jobs that the first schedule assigns to each machine is scheduled to be finished in a machine span, and
in a second iteration, either: (i) determine a constraint for at least one of the machine spans and determine a second schedule that solves the optimization problem for the set of jobs and the set of machines under the constraint, or (ii) determine a second schedule that solves the optimization problem for a sub-set of the set of jobs and a sub-set of the set of machines, wherein the sub-set of the set of machines excludes the machine and the sub-set of the set of jobs excludes jobs that are assigned to the machine according to the first schedule.

10. A non-transitory computer-readable medium on which is stored a computer program including computer readable instructions for machine scheduling for executing a set of jobs of a task with a set of machines, the instructions, when executed by a computer, causing the computer to perform the following steps:
determining, in a first iteration, a first schedule that solves an optimization problem, wherein the optimization problem is defined by a set of rules that assign the set of jobs to the set of machines, the first schedule maps each job of the set of jobs to one machine of the set of machines that is capable of processing the job, an execution of each of the jobs that the first schedule assigns to each machine is scheduled to be finished in a machine span, and
in a second iteration, either: (i) determining a constraint for at least one of the machine spans and determining a second schedule that solves the optimization problem for the set of jobs and the set of machines under the constraint, or (ii) determining a second schedule that solves the optimization problem for a sub-set of the set of jobs and a sub-set of the set of machines, wherein the sub-set of the set of machines excludes the machine and the sub-set of the set of jobs excludes jobs that are assigned to the machine according to the first schedule.
